(19) United States
(12) Patent Application Publication
(10) Pub. No.: US 2006/0117933 A1
(43) Pub. Date: Jun. 8, 2006

(54) Hand percussion brush

(76) Inventor: Solomon Danoff, Summerland, CA (US)

Correspondence Address: Sandy Lipkin;Law Offices of Sandy Lipkin, 803 Cambria Way, Santa Barbara, CA, 93105, US

(21) Appl. No.: 11/007,773

(22) Filed: Dec. 7, 2004

(51) Int. Cl. G10D 13/02

(52) U.S. Cl. 84/422.1

(57) ABSTRACT

A drum brush comprising a molded base with a strapping portion that slides over one or more fingers of the musician, a plurality of filaments of substantially the same length held together with a lateral member secured across one end of the bundle that emerges from a slit situated at or near the center of the molded base for use in the hand beating of percussion instruments to create sounds heretofore unachieved through hand drumming without the use of a handle.

### FIELD OF THE INVENTION

This invention relates to musical implements and more particularly to a percussion implement for impacting a percussion instrument.

### BACKGROUND OF THE INVENTION

Percussion instruments require the use of beaters to effect vibration of the head stretched over a generally cylindrical-shaped body constituting a drum or percussion instrument. Such beaters can contain various media to hit the drum or percussion instrument, including brushes made of wire or plastic as well as paired unitary wooden members. The prior art in the field is composed entirely of beating implements containing gripping handles for beating the percussion instrument. The prior art with regard to brush-type implements is comprised primarily of inventions designed to allow flexibility in the quality of sound achieved upon striking the drum and to protect the brushes from damage both during use and while in storage.

U.S. Pat. No. 5,404,787 to Kubach teaches of a brush-type drumbeating implement that contains a handle and a fan-like set of metal fingers that can be adjusted in shape to form a continuum of shapes from a single finger to a planar or fan-like spread. This variability in shape of the brush leads to flexibility and creativity in the quality of sound created by the musician. This invention also locks the desired shape of the metal fingers in place to allow for consistency of sound during use. Similar inventions with similar objectives are described by Phraener in U.S. Pat. No 4,200,026, by Calato in U.S. Pat. No. 4,028,983, by Cordes in U.S. Pat. No, 3,420,134, by Sage in U.S. Pat. No. 3,150,550 and by Goldrich in U.S. Pat. No, 2,513,930. All of these inventions contain beaters with handles.

Some prior art particularly sets out to protect the brush portion of the drumbeater while in use and when in storage. Gauger teaches in U.S. Pat. No. 6,162,979 of an adjustable drum beater containing a handle in which the handle contains a cavity that can receive the wire brush for storage as well as variable release of the brush creating a variable ability in sound quality. Cordes in U.S. Pat. No. 4,559,860 likewise discloses a drum brush with a tubular handle with variable spread for the brush, which also allows for prevention of kinking of the wire filaments in brush through storage in the handle.

Liedtke et al. teach in U.S. Pat. No. 4,590,839 of a drum brush containing pellets to create a sound unique from traditional percussion brush beaters. Similarly, Nicolosi in U.S. Pat. No. 6,002,077 and Vater in U.S. Pat. No. 5,728,958 describe a drumbeater that is somewhat of a hybrid between a traditional solid wood member and a brush, using multi-dowel systems in the place of the filament type percussion brushes. Again, all of these inventions contain beaters with handles for the musician to grip prior to striking the drum.

Certain types of percussion instruments, however, have traditionally used only the hand to beat the drum and create a vibration. Until now, brush type beaters have only been utilized with these types of percussion instruments using a beater with a handle. The creativity of the musician in creating sounds on these types of hand-beaten drums has been limited due to the fact that this particular form of drumming typically involves the use of the palms of the hands and not the beating of the drumhead with a handled implement. Furthermore, disabled persons without the ability to grip a handle have been unable to create sounds on such hand-beaten drums that can be manifested with the use of a brush type implement on the drumhead.

### SUMMARY OF THE INVENTION

In the preferred embodiment of the invention, a beating device for a drum containing a brush is described. The device is designed for use with hand percussion instruments that are often times and traditionally struck using the palm of the hand of the musician. The device is composed of a base molded to fit under the musician's fingers, on the palm side with a portion designed to fit around one or more fingers of the hand of the musician and containing a plurality of plastic or metal filaments emanating at or near the center palm side of the base.

On the palm side of the fastening device a slit is present which holds in place the filaments that create the brush portion of the beating device. The brush portion is a plurality of filaments that are composed of various media, such as metal wire or plastic, designed to create distinct sounds when striking the drumhead. The filaments form a fan shape at the top and extend out beyond the molded base portion of the device. The filaments are held in place through the slit with a bracing member that surrounds the plurality of filaments to prevent the filaments from slipping out of the top of the base. The filaments can also be adjusted longitudinally so that the plurality is situated at various lengths, thereby changing the shape of the fanned portion and the quality of the sound produced when the drum instrument is struck.

### OBJECTS OF THE INVENTION

The principal object of the invention is to allow a musician who creates sound vibrations through the hand beating of a percussion device to create new sounds, which are possible with the use of a percussion brush, while maintaining the creative flexibility peculiar to the method of drum beating involving the palm of the hands and not the gripping of a stick handle.

Another object of the invention is to allow percussion musicians who have disabling conditions which do not allow them to grip a handle to create the unique sounds made by the striking of a drumhead with a brush while beating on their instruments without having to grip a handle.

Another object of the invention is to allow the musician to quickly slip the device on and off while performing.

### BRIEF DESCRIPTION OF THE DRAWINGS

FIG. 1 illustrates a perspective view of the hand percussion brush invention from the perspective of the back of the hand, as it would appear prior to slipping it over the fingers of the musician.

FIG. 2 depicts a perspective view of the hand percussion brush invention from the perspective of the palm of the hand, as it would appear prior to slipping it over the fingers of the musician.

FIG. 3 depicts a side view of the hand percussion brush invention.

FIG. 4 depicts a perspective view of the hand percussion brush invention, as it would appear from the back of the musician's hand while it is affixed in place on the musician's hand.

### DETAILED DESCRIPTION OF AN ENABLING AND PREFERRED EMBODIMENT

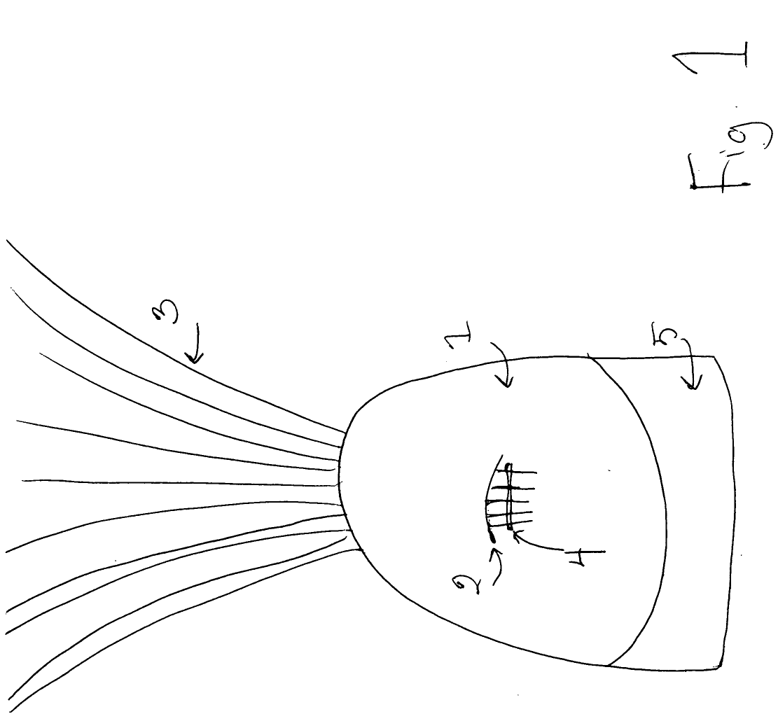

For a better understanding of the invention, turning now to the drawings, FIG. 1 illustrates a perspective view from the back of the hand of the musician. The molded base I is a one-piece mold, fabricated out of media such as plastic, with a strapping portion 5 designed to surround one or more fingers of the musician. A plurality of filaments 3 of substantially the same length emerges from the underside of the molded base 1 through a slit 2 sized to fit the plurality of filaments 3 in place. A lateral filament 4 is braced across the plurality of filaments 3 to keep the filaments from emerging from the slit 2 through the top. The position of the plurality of filaments 3 can be adjusted longitudinally downward to create a narrower shape to the fan portion of the filaments 3 thereby creating a wider variety of vibrations upon striking of the drum instrument.

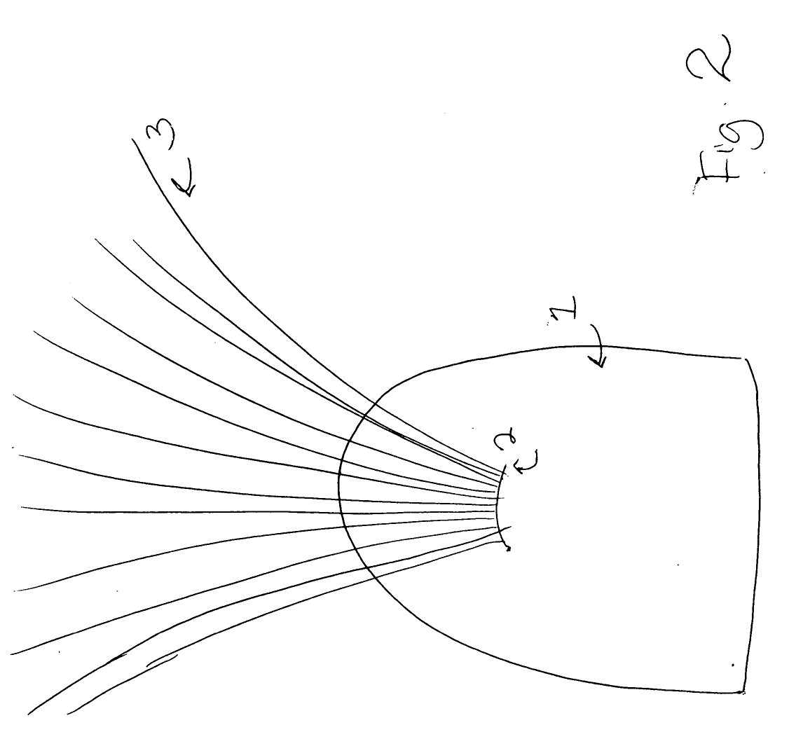

FIG. 2 illustrates a perspective view of the invention as seen from the palm side of the musician's hand. The molded base I is formed to rest under the fingers on the palm side of the hand of the musician. The plurality of filaments 3 emerges from the slit 2 situated at or near the center of the molded base 1.

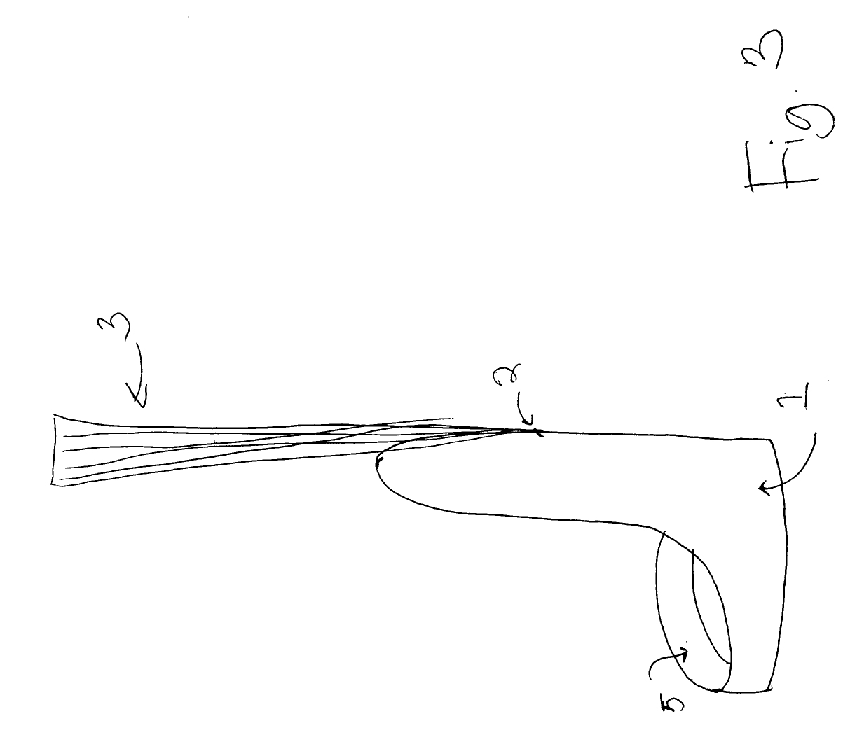

FIG. 3 is a side view of the invention. The molded base 1 contains a strapping portion 5 that slides over one or more of the fingers of the musician. The plurality of filaments 3 emerges from the molded base 1 through a slit 2 situated at or near the center of the molded base 1.

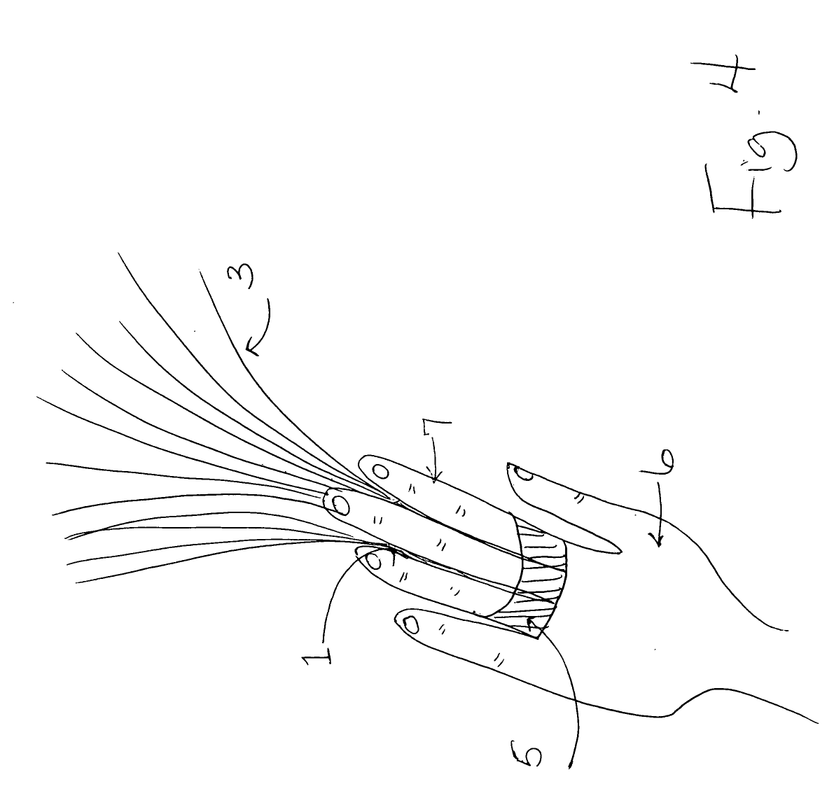

FIG. 4 is a top view of the invention as it appears once affixed to the hand 6 of the musician. The molded base 1 is resting under the fingers 7 on the palm side of the musician's hand 6 while the strapping portion 5 is placed over one or more of the musician's fingers 7. The plurality of filaments 3 emerges from the underside of the musician's hand 6.

The invention involves the sliding of the molded base I over one or more fingers 7 of the musician's hand 6. The molded base 1 contains a strapping portion 5 that slips over one or more of the fingers 7 of the musician's hand 6. The plurality of filaments 3 is then spread outward away from the palm of the musician's hand 6. The musician then is free to move his hands along the drumhead and create new sounds using the plurality of filaments 3 attached through the casing 4 of the invention.

The plurality of filaments 3 are held in place through the slit 2 through the use of a lateral member 4 affixed laterally across the plurality of filaments 3 to prevent the bundle from emerging completely from the top of the slit 2. Moving the plurality of filaments 3 longitudinally downward to various positions through the slit 2 can modify the quality of sound created by the striking of a drumhead with the device.

I claim:

1. A percussion beating device, comprising:
a molded base with a portion that fits under the palm side of a musician's fingers and a strapping portion that fits around one or more of a musician's fingers;
a slit situated at or near the center of said portion of the molded base that fits under the palm side of a musician's fingers;
a plurality of filaments of substantially equal length emerging from said portion of the molded base that fits under the palm side of a musician's fingers through said slit;
a laterally placed member across one end portion of the plurality of filaments securing the filaments in a bunch and preventing the emergence of the plurality entirely from the top of the molded base while maintaining the ability of the plurality to be repositioned as a bunch longitudinally through said slit.

2. A percussion-beating device as set forth in claim 1 wherein said filaments are made of metal wire.

3. A percussion-beating device as set forth in claim 1 wherein said filaments are made of plastic.

4. A percussion-beating device as set forth in claim 1 wherein said molded base fits only around one finger of the musician.

5. A percussion-beating device as set forth in claim 4 wherein said filaments are made of metal wire.

6. A percussion-beating device as set forth in claim 4 wherein said filaments are made of plastic.
